(19) United States
(12) Patent Application Publication
(10) Pub. No.: US 2003/0062723 A1
(43) Pub. Date: Apr. 3, 2003

(54) Portable power generating unit

(76) Inventors: Dennis Mancl, Bluff City, TN (US); Robert A. Howard, Palo Alto, CA (US); Daniel F. Kennedy, San Francisco, CA (US); Jeffrey Allen Salazar, Palo Alto, CA (US); Jeffrey L. Smith, San Mateo, CA (US)

Correspondence Address: HUGHES & LUCE LLP, 1717 MAIN STREET, SUITE 2800, DALLAS, TX, 75201, US

(21) Appl. No.: 10/184,423

(22) Filed: Jun. 28, 2002

Related U.S. Application Data
(60) Provisional application No. 60/301,525, filed on Jun. 28, 2001.

(51) Int. Cl. H02P 9/00

(52) U.S. Cl. 290/1 A

(57) ABSTRACT

A portable power supply for electrical appliances is disclosed that comprising of a wearable frame, a power generation unit, a fuel supply container, and an electrical appliance which is supplied electrical power from the electrical power generation unit and may be attached to the frame. Also disclosed is a method of using a portable electrical power unit with an appliance by storing a fuel supply in a container, converting the fuel to electrical power using an electrical power generator, operating an electrical appliance, the operator carrying the container and the electrical power generator while using the appliance.

### REFERENCES TO RELATED APPLICATIONS

This application is based on Provisional Application No. 60/301,525, filed Jun. 28, 2001. This application includes subject matter protected by copyright.

### TECHNICAL FIELD OF THE INVENTION

The present invention relates generally to a portable electrical power generating unit that can be used with electrical appliances, and specifically to a portable hydrogen fuel cell electrical power generating unit that can supply sufficent power to power electrical appliances such as a vacuum cleaner.

### BACKGROUND OF THE INVENTION

Portable power supply units adapted to be carried by an operator of an appliance are well known. Additionally, portable electrical appliances are well known, for example see U.S. RE No. 37,081.

Presently, portable electrical appliance designs that are available must deal with two considerations that affect customer choice and satisfaction. The first is the power requirement of the appliance. The second is the power supply available to the appliance.

Power requirements for appliances are usually directly related to the appliances performance in accomplishing the designed task. For example, when a customer desires a vacuum cleaner that is able to provide a stronger vacuum, the customer must choose a vacuum cleaner that will have greater electrical power requirements.

Additionally, when a customer is choosing a vacuum cleaner, often the extent of the portability is a consideration. For example, if a customer needs a vacuum cleaner for vacuuming a large area with few electrical power outlets, the customer may desire a vacuum cleaner with a battery powered source that is portable with the vacuum cleaner, so the operator is not limited by the length of the electrical power cord.

One problem associated with the conventional vacuum cleaner is that the electrical cord wire which is attached to the vacuum mechanism has been known to create several obstacles during use of operation such as (1) locating a proper electrical outlet in which to plug the wire that is compatible to the area of the room; (2) moving electrical cord wire out of the way of vacuuming; and (3) storage of the electrical cord. In these instances, a battery powered cordless vacuum cleaner is an improvement. However, a battery powered cordless vacuum cleaner has been known to have limitations as well. A battery powered cordless vacuum mechanism has limited power, typically less than 500 watts, and is unable to successfully complete the process of removing dirt and particles from a carpet.

### BRIEF SUMMARY OF THE INVENTION

A portable power supply for electrical appliances includes a wearable frame, an electrical power generation unit, and a fuel supply container. An electrical connection permits an electrical appliance to be connected to the electrical power generation unit and receive its power therefrom. The electrical appliance may also be attached to the wearable frame.

A method of using a portable electrical power unit with an appliance, the method comprising the steps of storing a fuel supply in a container, converting the fuel to electrical power using an electrical power generator, operating an electrical appliance, wherein the electrical appliance receives its electrical power from is the electrical power generator, and wearing the container and the electrical power generator on the back of an operator using the appliance.

A backpack comprising of a backpack frame, a portable electrical power generating unit attached to the frame, and an electrical appliance electronically coupled to the portable electrical power generating unit.

The foregoing has outlined some of the more pertinent objects and features of the present invention. These objects should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following Detailed Description of the Preferred Embodiment.

### BRIEF DESCRIPTION OF THE DRAWINGS

For a more complete understanding of the present invention and the advantages thereof, reference should be made to the following Detailed Description taken in connection with the accompanying drawings in which:

FIG. 1A shows an embodiment of the present invention in a schematic form;

FIG. 1B shows a side view of the embodiment of the invention whereby the fuel container is visible;

FIG. 2 shows another embodiment of the present invention, having a hinged cover;

FIG. 3 shows an embodiment of the present invention, whereby the unit is latched onto a frame;

FIG. 4 shows another embodiment of the present invention in a uniquely designed case;

FIG. 5 shows a different embodiment of the present invention, having a handle;

FIG. 6A shows an embodiment of a support unit for an embodiment of the present invention;

FIG. 6B shows another view of this embodiment of the invention, detailing different mounting techniques for a cover plate;

FIG. 7 shows the construction of a protective portion for an embodiment of the present invention;

FIG. 8 shows an oblique view of an embodiment of the present invention;

FIG. 9 shows an embodiment of the present invention as worn by an operator;

FIG. 9A shows a top view of one embodiment of the present invention;

FIG. 10 shows a composite diagram of an embodiment of the present invention;

FIG. 11 shows an electrical wiring schematic drawing for an electrical appliance utilized in an embodiment of the present invention;

FIG. 12 shows another embodiment of the present invention as worn by an operator;

FIG. 12A shows an electrical generator utilized in an embodiment of the present invention without its protective cover;

FIG. 13A shows another embodiment of the present invention in a modified form;

FIG. 13B shows the fuel container bracket pursuant to the present invention;

FIG. 13C shows a rear view of this embodiment of the present invention;

FIG. 14A shows a close up of a fuel regulating unit for an embodiment of the present invention;

FIG. 14B shows a schematic of the the fuel storage container and the fuel regulator with fuel line connected thereto to provide fuel to the electrical generation unit;

FIG. 14C is provided to show the fuel line connected to the fuel container via the regulating system;

FIG. 15A shows a side view of the electrical generation unit in an embodiment of the present invention;

FIG. 15B shows the on/off switch connected to electrical generating unit;

FIG. 16 shows a perforated cover for the fuel cell along with the location for the battery charging jacks for recharging the fuel cell batteries;

FIG. 16A shows a front view of the electrical power generating unit; and

FIG. 16B provides a back view of the electrical power generating unit.

### DETAILED DESCRIPTION OF THE INVENTION

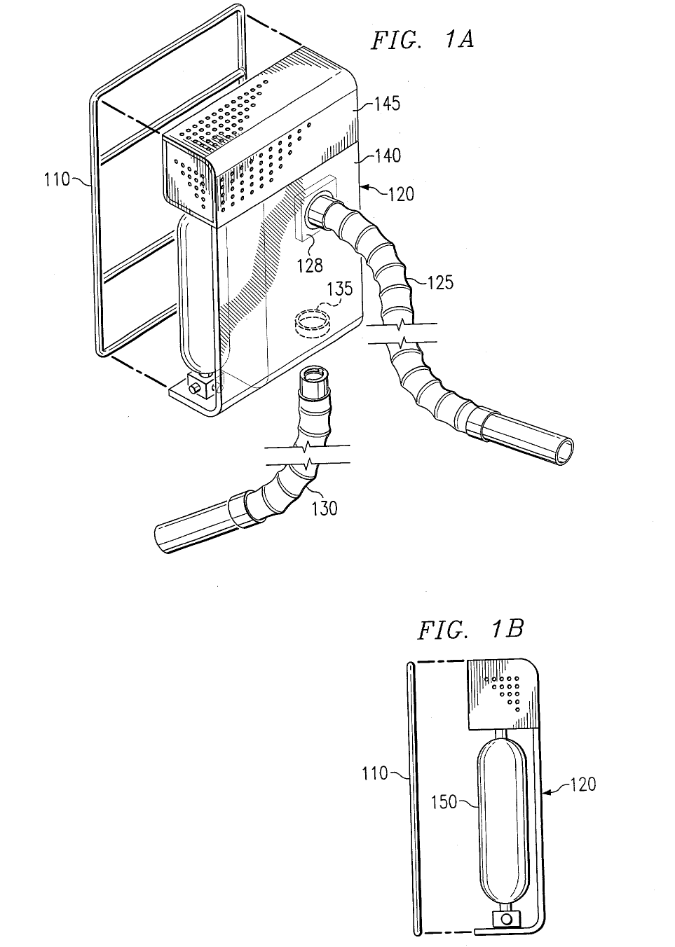

Referring now to the figures, FIG. 1A shows an embodiment of the present invention in a schematic form. In FIG. 1A, frame 110 provides support for the embodiment of the present invention 120 so that 120 is wearable upon an operator's back. In order to reduce costs, the sides of unit 120 are open. Blow hose 125 is attached to blow hose air filter connection 128, while suck hose 130 is attached to the base of unit 120 to the suction port 135.

In this embodiment of the present invention, the lower portion of case 140 is made of clear acrylic while the upper portion that houses the fuel cell may be made of perforated, or ventilated metal. FIG. 1B shows a side view of the present invention through the open side of unit 120 wherein the fuel supply storage container 150 can be seen.

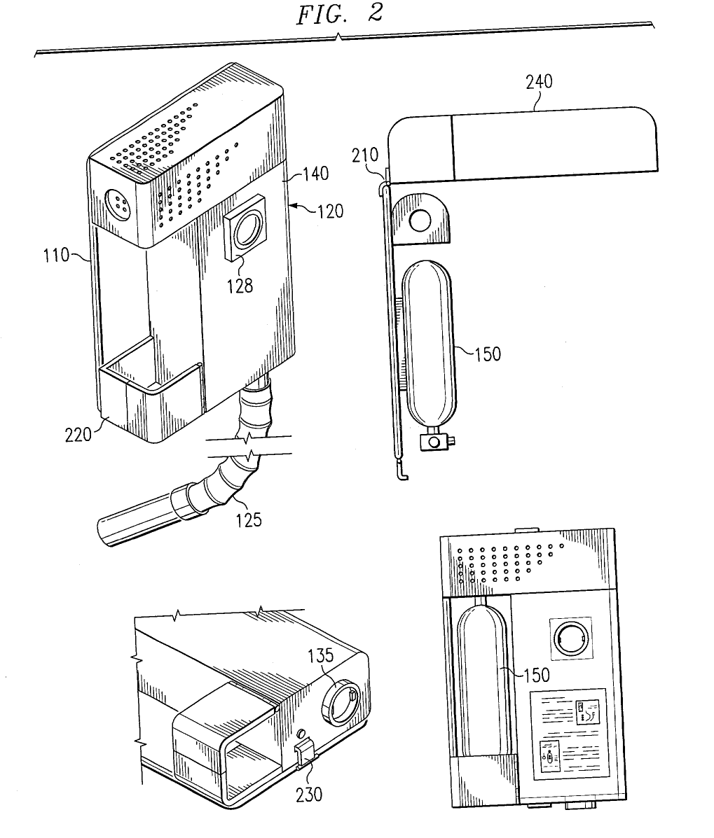

FIG. 2 shows another embodiment of the present invention. In FIG. 2 the case of unit 120 is attached to the top portion of frame 110 by hinge 210. Unit 120 provides a space for the fuel supply container on the left most portion of the unit. Elastic bumpers 220 are provided at the base of unit 120 on the left most portion to protect the fuel supply container. Latch 230 is provided at the base of frame 110 whereby cover 240 may be secured when the cover is placed in the closed position.

As before, suck hose 125 is attached to the lower portion of unit 120 through the suck hose connection 135. Blow hose connection 128 is provided for connection of a blow hose. Fuel storage container 150 can be inserted into the void located on the left most side and protected by elastic bumpers 220.

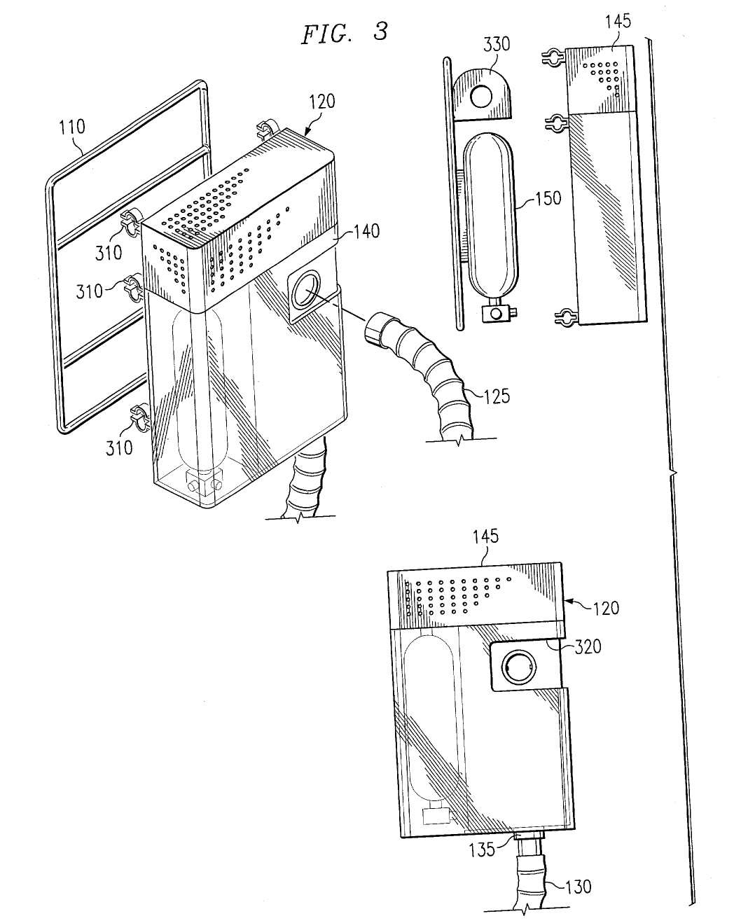

FIG. 3 shows another embodiment of the present invention, whereby unit 120 is latched onto frame 110. In FIG. 3, latches 310 hook on to frame 110 so that frame 110 supports unit 120 while the unit is worn on the back of the operator. The blow hose connection/air filter latch 320 is utilized to latch body 140 and connect blow hose 125 to the invention. Suck hose 130 is attached to suck hose connection 135. Power generator 330 is provided ventilation and protection by upper portion 145 and body 140 protects fuel supply container 150 when unit is attached to frame 110.

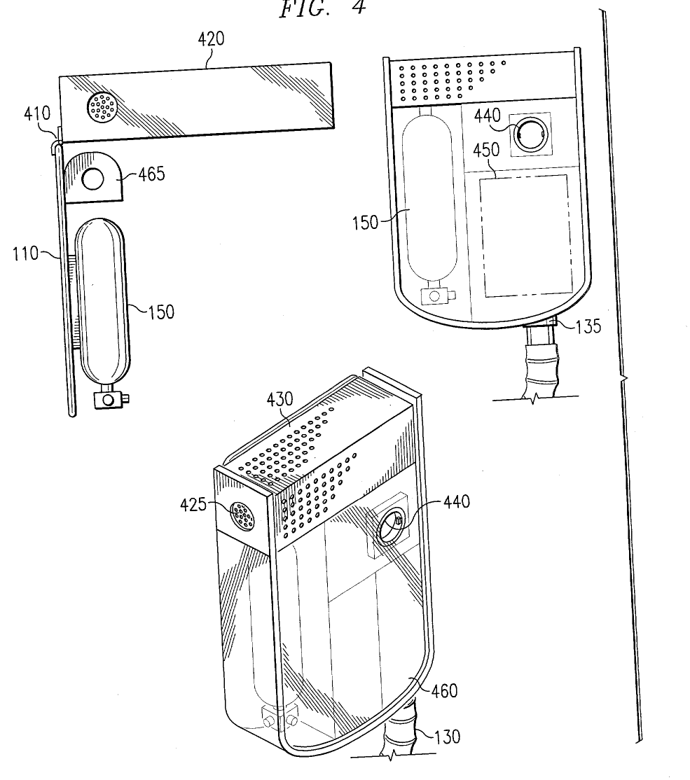

FIG. 4 shows the present invention in a uniquely designed case. Unibody 420 is attached to frame 110 by hinge 410. Unibody 420 includes an intake vent 425 to allow air to flow over the fuel cell, which is located on the upper portion of the unit underneath the ventilation portion 430. The side portion of unibody 420 is constructed with elastic material to absorb shock from the operator's use. Fuel storage container 150 is attached to frame 110, as is fuel cell 460. Unibody 420 can be lifted up to gain access to fuel supply container 150 or to fuel cell 465, or the appliance located underneath unibody at location 460. Unibody 420, when closed latches to frame 110 using either magnets or mechanical means. Unibody 420 is made of acrylic to allow instructions for operation of the present invention to be attached in area 450. Blow hose connection/filter 440 is provided as is suck hose connection 135 where suck hose 130 can be attached for operation.

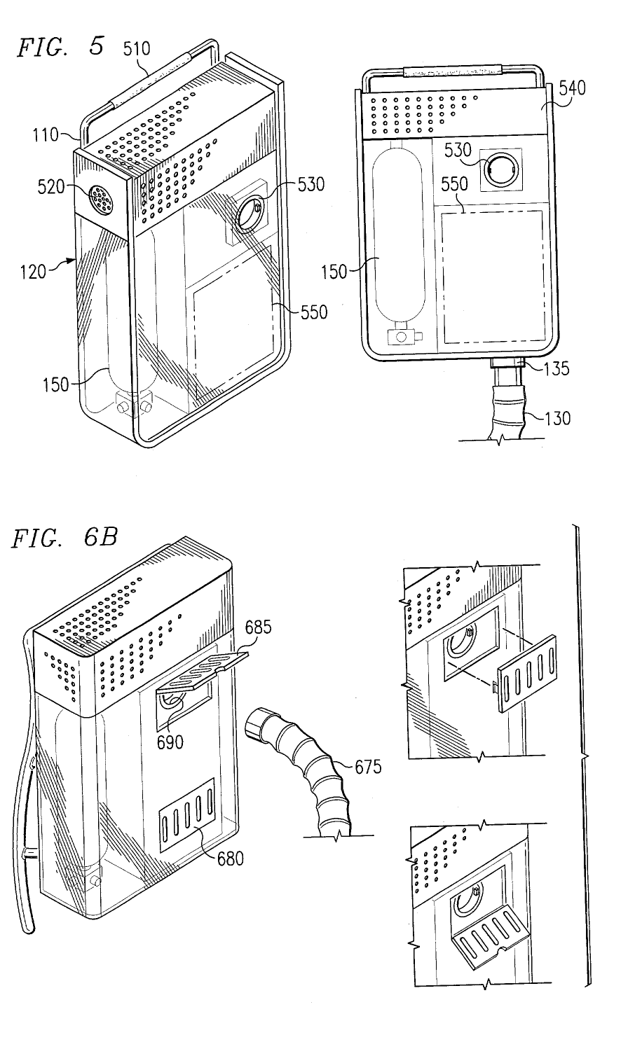

FIG. 5 shows the present invention wherein unit 120 is provided in a different embodiment. In FIG. 5, frame 110 extends beyond the top of unit 120 to form a handle 510. Handle 510 can be utilized to carry the unit. Air intake vent 520 is located on body 120 and is provided on the side to allow for airflow over and through the fuel cell located underneath section 540. An acrylic portion covers fuel container 150 and space 550 is provided for instructions. Blow hose connection/filter 530 is provided as well as suck hose connection 135 for suck hose 130. The appliance is located underneath portion 550.

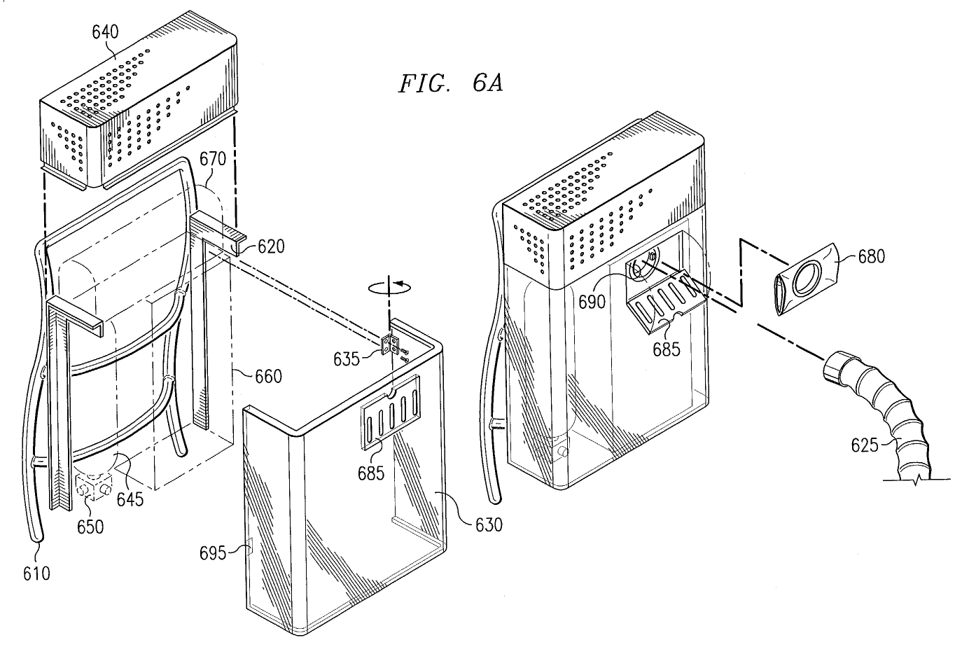

FIG. 6A shows another embodiment of a support unit for the present invention. In FIG. 6A, frame 610 is used to support the weight of the unit on the operator's back. Brackets 620 are provided to accept case 630 when case 630 is used to enclose the vacuum cleaner 660 and fuel storage container 645. Protective cover 640 is utilized and placed on top of fuel cell 670 to protect fuel cell 670. Protective cover 640 is corrosion resistant and perforated to allow air to flow over fuel cell 670. Cover 630 contains protective plate 685, wherein filter 680 can be placed interior to the protective cover 685. Blow hose connection 690 is modified to accept filter 680 during operations when vacuum cleaner 660 is utilized as a vacuum cleaner. During operations wherein vacuum cleaner 660 is utilized as a blower, hose 625 can be connected to blow hose connection 690. When body 630 is slid in through bracket 620, a magnetic latch 695 is utilized to secure body 630 to frame 610 in bracket 620. Hinge 635 is provided on the vacuum cleaner side of unit 600, wherein body 630 may be swiveled opened to gain access to the contents therein.

Protective cover 685 contains air vents to allow air to pass through the protective cover. Additionally, protective cover 685 can be designed to allow for various methods of removal to gain access to either the filter 680 or blow hose connection 690 with hose 675. As shown in FIG. 6B, protective cover 685 can be attached by hinge either at the top to flip up, at the bottom allow it to flip down, or it can be attached with a latching system so that the entire protective cover may be removed. When not employed over blow hole connection 690, filter 680 can be stored as shown under another protective cover.

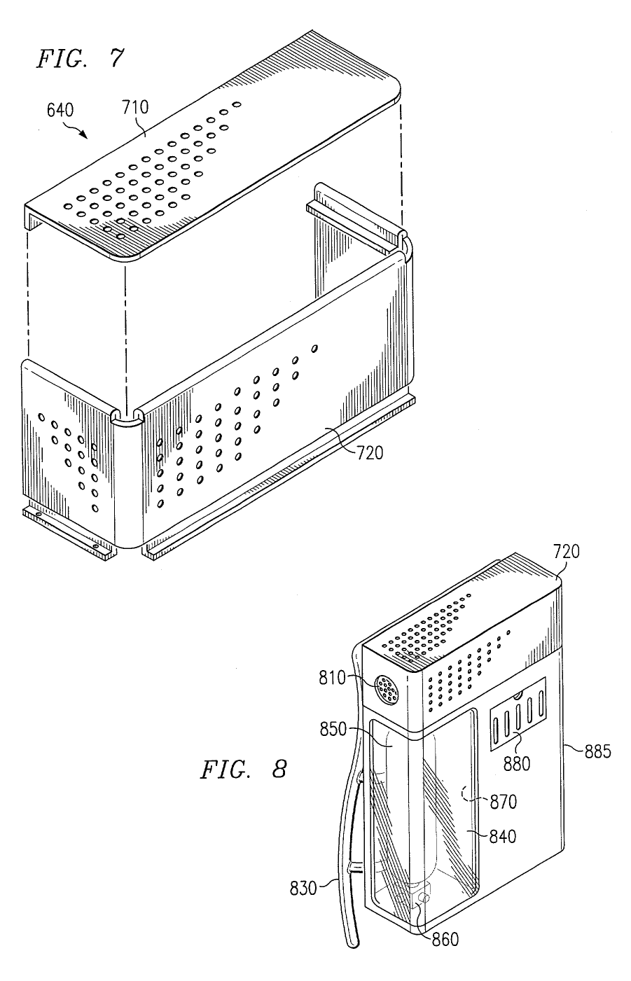

FIG. 7 shows the construction of protective portion 640. The top perforated portion 710 is connected to U-shaped body 720, which is also perforated. Once connected, body 720 is attached to either frame 610 or brackets 620 of FIG. 6A so that it is secured to protect fuel cell 670. In order to protect the fuel cell, 720 is attached using a nut and bolt, or screw mechanism.

FIG. 8 shows an oblique view of an embodiment of the present invention. Protector 720 is attached on top of body 885. The fuel cell is protected by 720 and fits underneath it on top of the contents located inside body 885. Air vent 810 is located on either side of protector 720 to allow airflow across the fuel cell. Frame 830 is attached to the contents interior to 885 and 720, including the fuel container 850, fuel regulator 860 and appliance 870. Protective cover 880 is attached to cover 885 to protect both the air filter and blower/air filter connection port. A clear window, 840, provides the operator with a view of fuel container 850 and regulator 860.

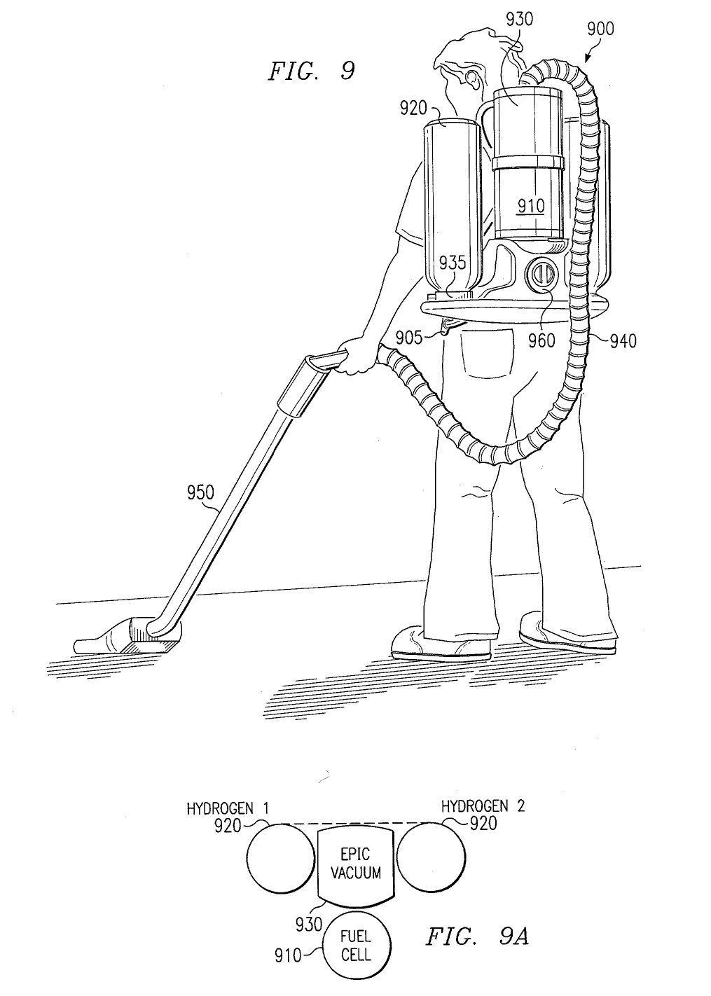

FIG. 9 shows an embodiment of the present invention as worn by an operator. Unit 900 is attached to a frame 905, which is supported on the shoulders of the operator. Attached to frame 905 is the electrical power-generating unit or fuel cell 910, a fuel storage unit 920 and a fuel regulator 935. The electrical power generating unit provides power to an electrical appliance, in this case a vacuum cleaner 930 which is located behind the fuel cell and closest to the operator in the present figure. Power may be applied in either alternating or direct current. A suction hose 940 is attached to the vacuum 930 and a handle extension 950 is attached to the hose for operator use. Port 960 is provided to allow the operator to attach a hose thereto for the option of blowing rather providing a vacuum.

FIG. 9A shows a top view of the embodiment of the present invention shown in FIG. 9. In FIG. 9A two fuel storage units 920 are located on either side of the electrical appliance, in this case a vacuum cleaner 930. Fuel cell 910 is located exterior to the vacuum relative to the operator.

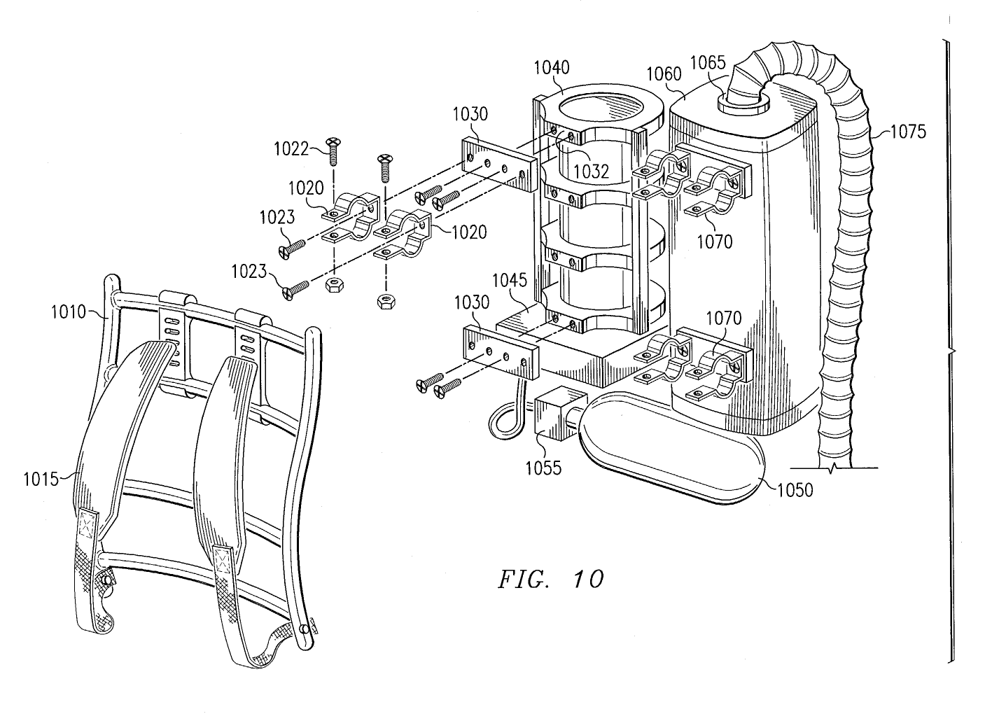

FIG. 10 shows a composite diagram of an embodiment of the present invention. Frame 1010 has shoulder straps 1015 attached thereto, in order for an operator to wear the frame. Electric power generator 1040 is vertically mounted to a support block 1045. Fuel supply container 1050 and regulator 1055 are attached to the support block and located underneath the generator 1040 and appliance 1060. Support block 1045 also contains certain electronics, which monitor the electrical fuel generation. Electric generator 1040 is attached to frame 1010 using clamps 1020 and steel plate 1030. Clamps 1020 are attached to steel plate 1030 using screws 1023 which attach the plate to the generator at support units 1032. Clamps 1020 are then attached to frame 1010 and tightened using screws 1022.

Electrical appliance 1060 is attached to frame 1010 using clamps 1070 which are similar to clamps 1020. Screws similar to 1022 are used to clamp the electrical appliance 1060 to frame 1010. In this case electrical appliance 1060 is a vacuum cleaner with hose 1075, which is coupled to the electrical appliance 1060 using the suction hose port 1065.

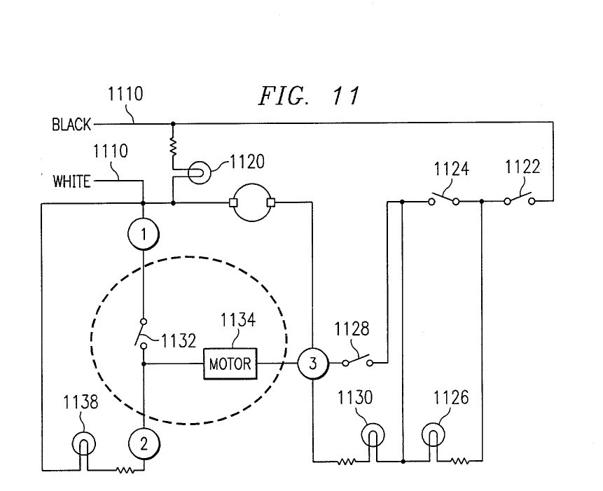

FIG. 11 shows an electrical wiring schematic drawing for the electrical appliance, in this case a vacuum cleaner, utilized in an embodiment of the present invention. Electrical power supplied from the electrical power generating unit is supplied at connection point 1110. Upon electrical power being supplied, the “plug in” light 1120 will illuminate to give the operator indication that electrical power is available to the appliance. Upon power being applied, motor 1134, which can be wound in either AC or DC mode depending on the type of power being supplied from the power generator, is available for operation. Thermistor, 1132, is provided to provide indication of an over temperature indication whereupon “over temperature” indicator 1138 will illuminate if thermister 1132 is closed.

Additionally various switches are provided so that the user has an indication as to whether a bag present or the bag is full. Switch 1128 is closed when the bag is present. Switch 1124 will remain closed if the bag is not full. Switch 1122 is provided so that the operator can turn on or turn off the vacuum cleaner as desired. If the bag is full in the vacuum cleaner, switch 1124 will open thereby providing electrical current to “bag full” light 1126, which will illuminate. Additionally if no bag is present, switch 1128 will remain open whereby “no bag” light 1130 will illuminate.

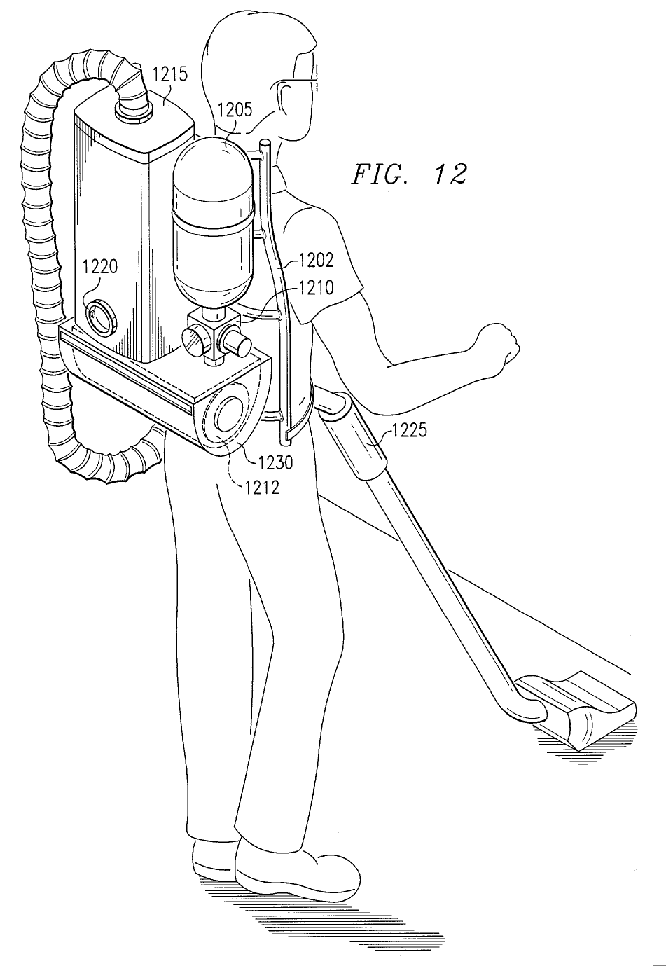

FIG. 12 shows another embodiment of the present invention as worn by an operator. Frame 1202 is worn by the operator. Fuel storage container 1205 is attached to the frame and connected to the electrical generator 1212 through regulating system 1210. Vacuum cleaner 1215 is electrically connected to the electrical fuel generator 1212 and to remote switches on hose 1225, whereby the operator is able to turn on the vacuum cleaner and perform vacuum operations using the switches and hose 1225. Blowhole/filter connection 1220 is provided to allow the operator to utilize the vacuum cleaner as a blower. In FIG. 12, the protective cover 1230 is provided over the top of electrical generator 1212.

FIG. 12A shows electrical generator 1212 without cover 1230. Electrical generator 1212 is attached to frame 1202 via brackets 1203 and standoffs 1204. Electrical generator 1212 is a hydrogen fuel cell capable of generating 20 amps at 48 volts DC, which is 960 watts of power. Additionally, the electrical generator is electrically connected to appliance 1215, in this case a vacuum cleaner, via the electrical connections 1213. This illustration shows the blowhole/air filter connection 1220. Fuel supply container 1205 is not installed in this view of this embodiment of the invention.

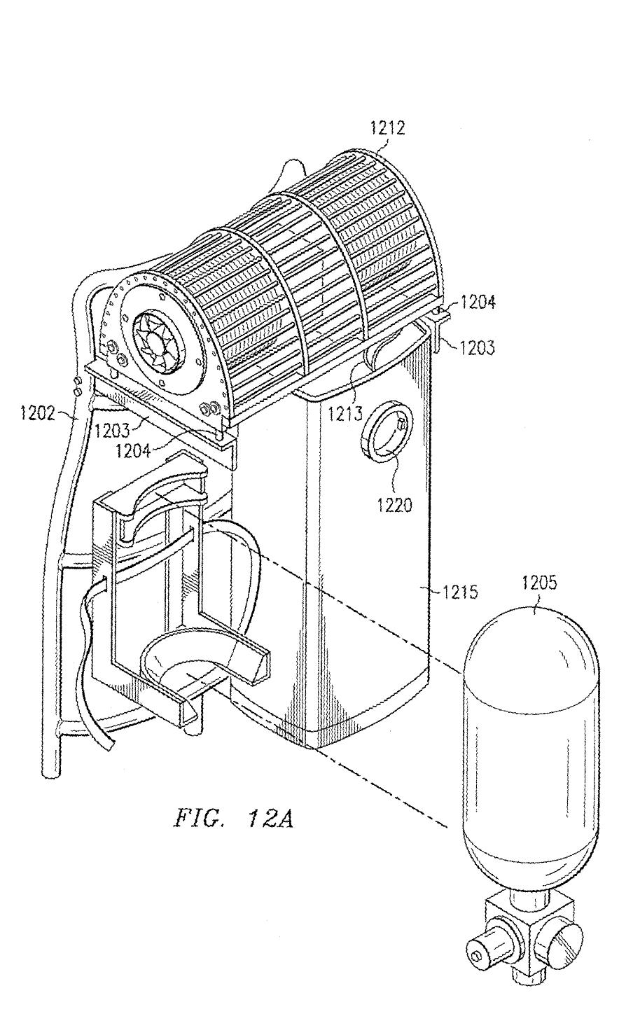

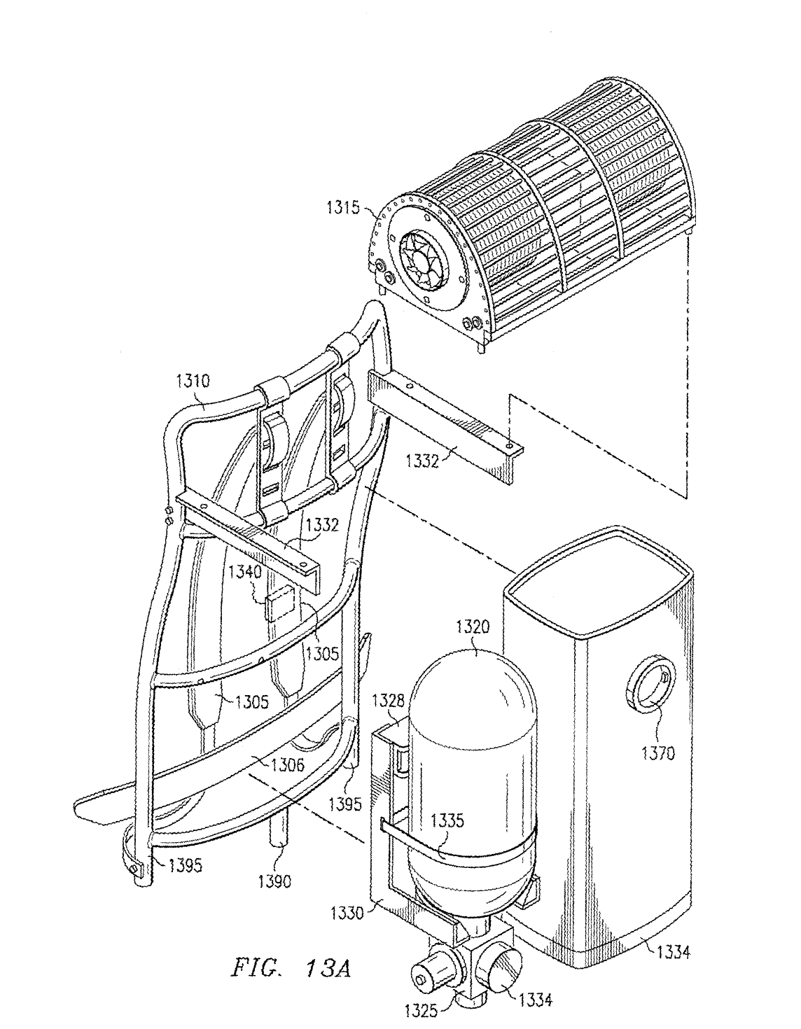

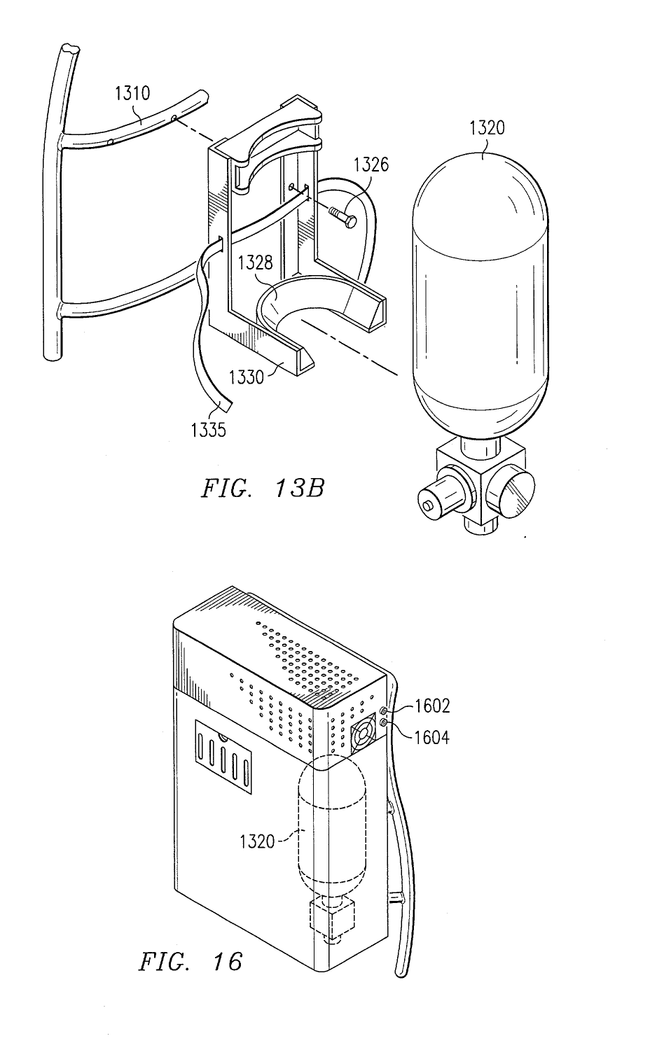

FIG. 13A shows theis embodiment of the present invention in a modified form. In the present invention, straps 1305 are attached to frame 1310. Straps 1305 are worn by the operator to allow the operator to carry the present invention. On strap 1305 is control unit 1340 which allows the operator remotely to turn on or turn off the vacuum cleaner and the fuel cell. The base of frame 1310 provides two legs 1395 which are used to support the unit in an upright position, and allow the unit to stand upright on a level surface. Brackets 1330 and 1332 are provided to attach various components to the frame 1310. Electrical generating unit 1315 is attached to bracket 1332, and fuel container 1320 is attached to frame 1330.

Regulating unit 1325 is provided to regulate fuel flow to the electrical generating unit. Additionally, appliance 1334 is attached to the frame to complete this embodiment of the present invention. Strap 1335 is used to hold fuel container 1320 in place.

FIG. 13B shows a fuel container bracket used in this embodiment of the present invention. Bracket 1330 includes straps 1335, which hold the fuel container into the bracket. Elastic piece 1328 is provided to is allow the fuel container to sit within the bracket and to absorb mechanical shocks to the system, minimizing those shocks that are transferred to the fuel container. Bolt 1326 attaches bracket 1330 to frame 1310 in order to secure the fuel container holding device.

FIG. 13C shows a rear view of the present invention. Frame 1310 is provided for support of electric fuel generator 1315, fuel supply container 1320, and electric appliance 1340, in this case a vacuum cleaner. Fuel container support bracket 1330 supports fuel container 1320 which is secured by strap 1335.

Elastic support 1328 reduces shock to fuel supply container 1320. Fuel gauge 1334, which is attached to fuel regulating system 1325, provides the operator with an indication of the pressure and thus the amount of fuel remaining. Electrical generating unit 1315, which receives fuel from fuel container 1320 via fuel regulator 1325, is attached to brackets 1332 and electrically connected to appliance 1340 through electrical connections 1380. Blowhole connection/air filter holder 1370 is provided for the operator to use the appliance as a blower. The base of frame 1310 provides two legs 1395 and a third leg 1390 so that the unit will stand on a level surface.

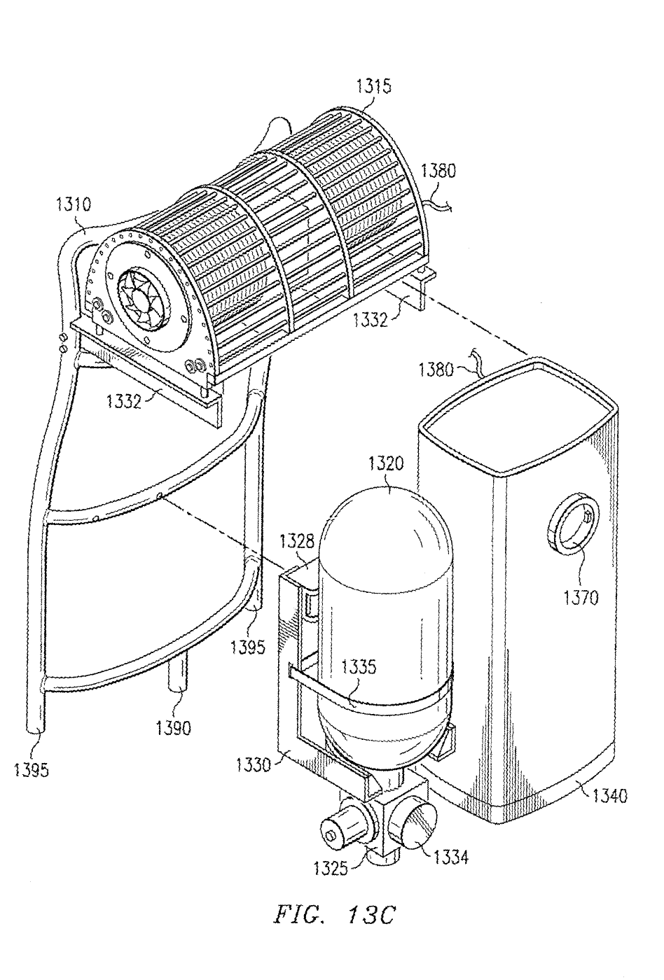

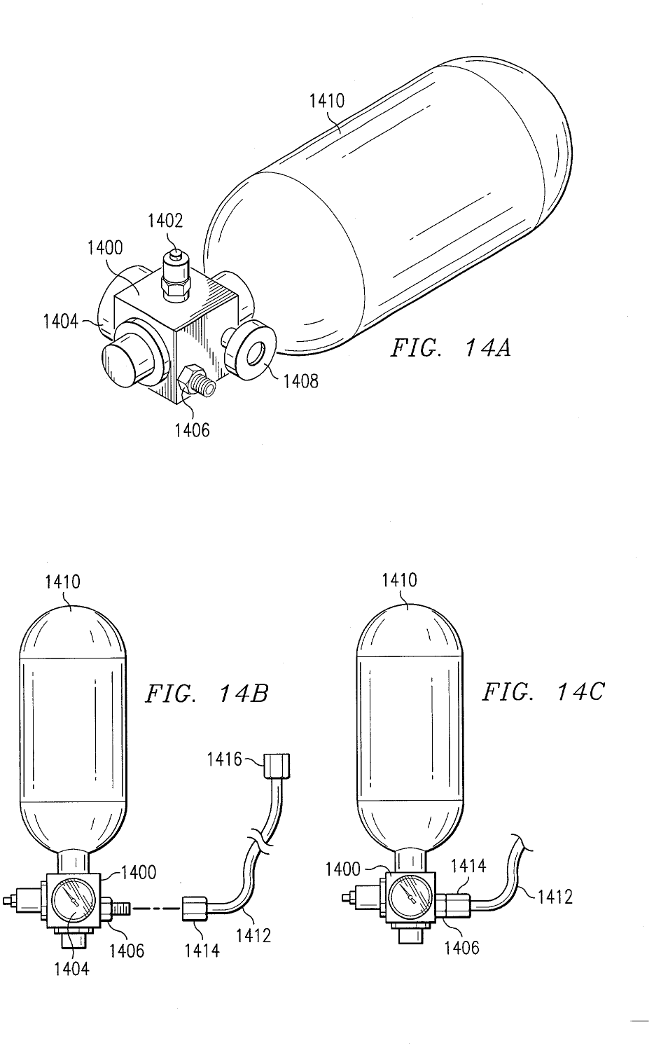

Referring to FIGS. 13A through FIG. 13C, in order to start the system the operator should proceed as follows. The operator should check that the red power switch on unit 1340 on strap 1305 is in the off position. Next, the operator should open the shut off valve at the pressure regulating unit 1325 completely. This will take several complete counter clockwise rotations of the black plastic knob which is shown in FIG. 14A as knob 1408. The operator will typically will need to open the main enclosure door to gain access to the shut off valve.

Upon closing the enclosure doors, the operator should put the backpack on the operator's shoulders. This is most easily accomplished by placing the backpack on the edge of the table and stepping backwards into the backpack. By adjusting shoulder straps 1305 for comfort and securing the raised harness 1306, the operator is able to help reduce the load on the operator's shoulders. Next the operator should attach any vacuum accessories that the operator will be using, such as a suction hose.

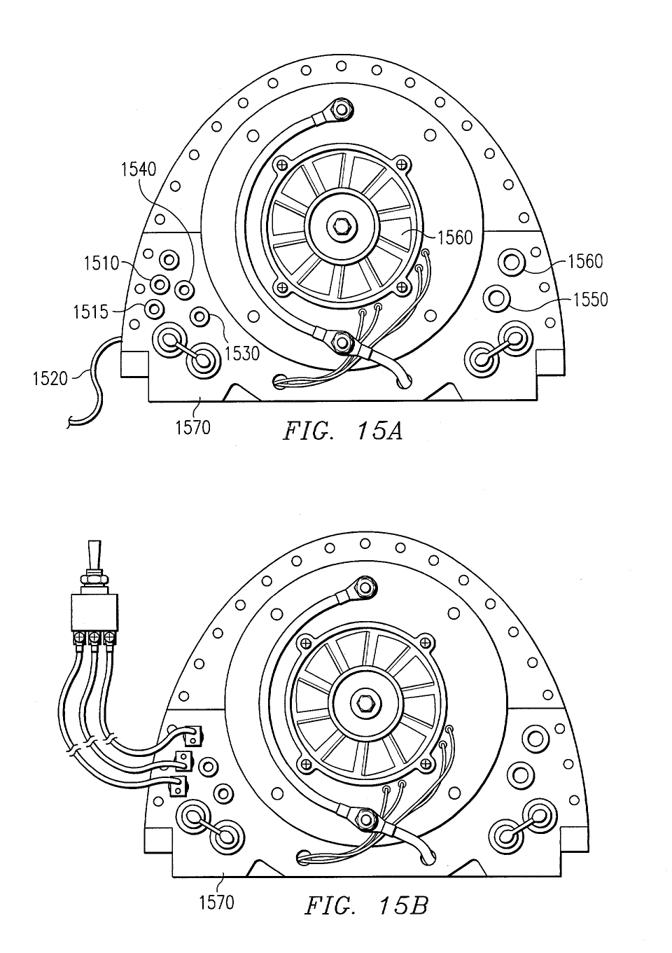

For normal vacuum operation, the operator should attach the accessory hose to the vacuum port at the bottom of the backpack. If the operator chooses to use the backpack as a blower, the operator needs to remove the filter from the exhaust port 1370 and connect the hose thereto. Next the operator shall turn on the red power switch located on the strap mounted control panel 1340. The operator should hear certain pneumatic valves opening and hydrogen gas being purged while the electrical fuel generating unit is slowly ramping up to full power. Shortly thereafter, power will reach to the vacuum system and the operator can use the vacuum normally. After the system has been warmed up, approximately 30 seconds after systems start, the fuel cell cooling fans 1560 as shown in FIG. 15A will speed up and the operator will notice a significant increase in fan and vacuum sound.

In order to stop the system the following steps should be used. First, the operator should turn off the red power switch located on unit 1340. The fuel cell will power down and the voltage at the fuel cell clamps will fall to 0 volts DC within a few minutes. Next the operator should detach all vacuum cleaner accessories from the vacuum unit 1340. Next the operator should remove the backpack from the operator's shoulder, and finally close off the shut off valve at the pressure regulating unit by turning it clockwise until it stops.

FIG. 14A shows a close up of a fuel regulating unit for an embodiment of the present invention. Fuel container 1410 is connected to regulating unit 1400. A fill cap 1402 is provided in order to fill the fuel storage container without removing the storage container from the regulating unit. Pressure gauge 1404 is provided in order to provide an indication of the amount of fuel remaining in fuel container 1410. Shut off valve 1408 is provided in order to cut the flow of fuel to the electrical generator, either to secure the electrical generation unit or to store the present invention for long periods of time and retain the fuel contents within the container. Fuel outlet valve 1406 is provided in order to connect the fuel regulator to the electrical generation unit.

FIG. 14B shows a schematic of this embodiment of the present invention with fuel outlet hose connected thereto to provide fuel to the electrical generation unit. Pressure gauge 1404 is provided to indicate the pressure within the fuel container. Fuel outlet valve 1406 is provided as the male end for fuel tube 1412 which has female end 1414. Fuel tube 1412 has enough length to connect to the power generation unit via the female end 1416.

FIG. 14C is provided to show fuel tube 1414 connected to the fuel container via the regulating system. Fuel tube 1412 is connected to the pressure regulating unit via connection 1414. Fuel tube 1412 runs the entire length of the fuel container to reach the electrical generation unit.

FIG. 15A shows a side view of the electrical generation unit. Fuel cell 1570 provides for various electrical connections to the appliance and batteries as will be explained below. Fan 1560 is provided to ensure smooth airflow over the fuel cells. Battery charging ports 1530 and 1540 are provided to recharge the fuel cell batteries as necessary. Female connections 1560 and 1550 are provided to connect to an electrical appliance. Additional female connections are provided in connections 1530 and 1540 for an external battery charging of the fuel cell battery. The fuel cell will contain microprocessors for more efficient operations. Connector 1510 is provided to provide a switched input to start the microprocessor. Jack 1505 provides battery voltage to the remote operating device 1340 which is located on the strap. Electrical jack 1515 is provided to provide switched power to the electronics of the fuel cell during starting. Finally, an additional lead for the LED battery indicating unit is provided at wire 1520. FIG. 15B shows the on/off switch connected to electrical generating unit.

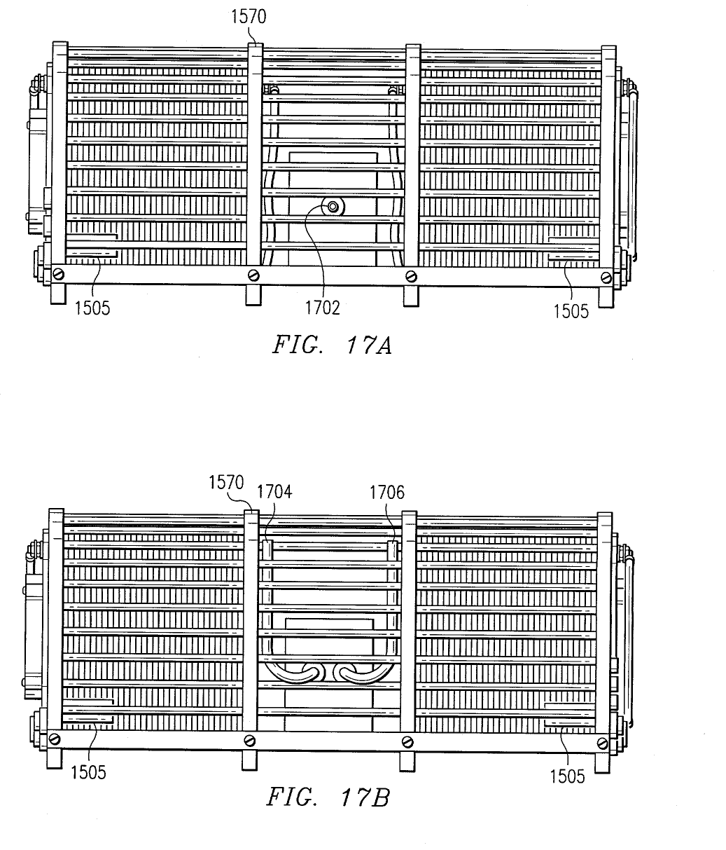

Refer now to FIG. 16, which shows the perforated cover for the fuel cell along with the location of the battery charging jacks for recharging the fuel cell batteries. The fuel cell batteries should last for at least 25 starting procedures. If the system fails to start up, this could be a sign that the batteries need to be recharged. In order to recharge the batteries, the system must be off. Next the operator should attach an external DC power supply to the positive and negative charging jacks 1602 and 1604 on the fuel cell system. Next the operator should adjust the supply to an output voltage of 11.5 volts DC and a maximum current of 0.5 amps. Next the operator should allow the batteries to charge until the current drops to about 0.2 amps. This should take less than 2 hours. Upon completion of the charge, the operator should disconnect the external power supply.

If the operator decides to store this embodiment of the present invention, the following guidelines are provided. The operator should evacuate the fuel container bottles 1320 by using the discharge tube. Next the operator should keep the system locked in its protective shipping container when not in use. Next the operator should use tape to secure the red power switch in the off position. If the power switch is actually switched on while in storage, the LED indicators will discharge the onboard control batteries and the operator will need to recharge the batteries prior to use.

FIG. 17A shows a front view of the electrical power generating unit 1570. Fuel inlet port 1702 is provided to connect the fuel tube to the electric power generating unit. This allows fuel to be carried from the fuel container to the power generating unit. FIG. 17B provides a back view of the electrical power generating unit. In FIG. 16B two hydrogen outlet ports, 1704 and 1706, are provided for periodic purging. Rechargeable batteries 1505 can be seen in both Figures. Rechargeable batteries 1505 are connected at various locations on the underneath portion of the electrical generating unit to provide for power during start up.

Having thus described our invention, what we claim as new and desire to secure by Letters Patent is set forth in the following claims.

What is claimed is:

1. A portable power supply for electrical appliances comprising of:
a wearable frame;
an electrical power generation unit attached to the frame;
a fuel supply container, attached to the frame and connected to the power generation unit; and
an electrical connector, whereby an electrical appliance may be connected to the electrical power generation unit and supplied electrical power therefrom, wherein the portable power supply can be worn by the operator of the electrical appliance.

2. The portable power supply of claim 1, wherein the electrical appliance is attached to the frame.

3. The portable power supply in claim 1 wherein the electrical power generation unit generates at least 550 watts of power.

4. The portable power supply in claim 1 wherein the fuel supply container contains hydrogen, and the electrical power generation unit comprises a hydrogen fuel cell.

5. The portable power supply in claim 1 wherein the electrical power generation unit provides a DC voltage to the appliance.

6. The portable power supply in claim 1 wherein the electrical appliance is a vacuum cleaner.

7. The portable power supply in claim 1 wherein the electrical appliance is a lawn mower.

8. The portable power supply in claim 1 wherein the electrical appliance is a blower.

9. A method of using a portable electrical power unit with an electrical appliance, the method comprising the steps of:
storing a fuel supply in a container;
converting the fuel to electrical power using an electrical power generator;
operating an electrical appliance, wherein the electrical appliance receives its electrical power from the electrical power generator; and
carrying the container and the electrical power generator while operating the electrical appliance.

10. The method of claim 9, wherein the carrying step further comprises the steps of:
securing the container to a frame;
securing the generator to the frame;
securing the appliance to the frame; and
placing the frame on the back of the operator, wherein the frame has adjustable straps that allow the operator to position the frame comfortably on his shoulders.

11. The method of claim 9 wherein the operating step further comprises the steps of:
the operator initiating a start sequence for the power generator; and
the operator turning on the appliance.

12. The method of claim 9, wherein the step of converting further comprises the step of creating a minimum of 550 Watts of electrical power.

13. The method of claim 9 wherein the operating step further comprises the steps of:
the operator remotely initiating a start sequence for the power generator using a remote switch; and
the operator remotely turning the appliance using a remote switch.

14. The method of claim 9 wherein the appliance is a vacuum cleaner.

15. The method of claim 9 wherein the appliance is an electric blower.

16. The method of claim 9 wherein the appliance is an electric lawn mower.

17. The method of claim 9 wherein a voltage output of the power generator to the appliance is at least 48 Volts and direct current.

18. The method of claim 9 wherein the stored fuel is hydrogen and the step of converting further comprises the step of converting the hydrogen into electrical power using a hydrogen fuel cell.

19. A backpack comprising:
a backpack frame;
a portable electrical power generating unit attached to the frame; and
an electrical connector whereby an electrical appliance can be electronically coupled to the portable electrical power generating unit.

20. The backpack of claim 19 further comprising an attachment device wherein the electrical appliance can be attached to the frame.

21. The backpack of claim 19 wherein the portable electrical power generating unit generates at least 550 Watts of power.

22. The backpack of claim 19 wherein the appliance is a vacuum cleaner.

23. The backpack of claim 19 wherein the appliance is an electric lawn mower.

24. The backpack of claim 19 wherein the appliance is an electric blower.

25. The backpack of claim 19 wherein the portable electrical power generating unit further comprises;
a fuel supply repository; and
a electrical power generator connected to the fuel supply repository wherein the fuel is converted to electrical power.

26. The backpack of claim 25 wherein the fuel supply repository contains hydrogen.

27. The backpack of claim 25 wherein the electrical power generator generates direct current.
